(19) United States
(12) Patent Application Publication
(10) Pub. No.: US 2025/0274799 A1
(43) Pub. Date: Aug. 28, 2025

(54) TERMINAL, RADIO COMMUNICATION METHOD, AND BASE STATION

(71) Applicant: NTT DOCOMO, INC., Tokyo (JP)

(72) Inventors: Naoya Shibaike, Chiyoda-ku, Tokyo (JP); Yuki Matsumura, Chiyoda-ku, Tokyo (JP); Satoshi Nagata, Chiyoda-ku, Tokyo (JP); Jing Wang, Beijing (CN)

(73) Assignee: NTT DOCOMO, INC., Tokyo (JP)

(21) Appl. No.: 18/859,869

(22) PCT Filed: Apr. 27, 2022
(86) PCT No.: PCT/JP2022/019128

§ 371 Date: Oct. 24, 2024

(51) Int. Cl. H04W 24/10; H04B 7/01

(52) U.S. Cl. CPC H04W 24/10; H04B 7/01

(57) ABSTRACT

A terminal according to one aspect of the present disclosure includes a control section that performs a measurement on a Doppler shift of a channel state information (CSI)-reference signal (RS) and determines channel state information (CSI) based on the measurement, and a transmitting section that transmits a reporting of the CSI. According to one aspect of the present disclosure, the measurement/reporting on the impacts of movement can be properly performed.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), reporting of channel state information (CSI) based on the reception of a reference signal is under study. Improving communication performance of moving terminals or terminals moving at a medium speed (user terminal, User Equipment (UE)) is also under study.

However, little progress has been made in studying the measurement/reporting on the impacts of movement. Communication throughput, communication quality, etc. may degrade unless such methods are clearly specified.

One of the objectives of the present disclosure is therefore to provide a terminal, a radio communication method and a base station that properly performs measurement/reporting on the impacts of movement.

### Solution to Problem

A terminal according to one aspect of the present disclosure includes a control section that performs a measurement on a Doppler shift of a channel state information (CSI)-reference signal (RS) and determines channel state information (CSI) based on the measurement, and a transmitting section that transmits a reporting of the CSI.

### Advantageous Effects of Invention

According to one aspect of the present disclosure, the measurement/reporting on the impacts of movement can be properly performed.

### BRIEF DESCRIPTION OF DRAWINGS

FIG. 1 is an example of a 16-level quantization table.

FIG. 2 is an example of an eight-level quantization table.

FIGS. 3A and 3B are examples of an Rel-16 type 2 port selection codebook.

FIGS. 4A and 4B are examples of an Rel-17 type 2 port selection codebook.

FIG. 5 is an example of a relationship between a CSI-RS resource and a CSI reporting.

FIG. 6 is an example of resources of a time domain and a frequency domain of a TRS.

FIGS. 7A and 7B are examples of cases 1-1 and 1-2.

FIG. 8 is a diagram illustrating an example of a schematic configuration of a radio communication system according to one embodiment.

FIG. 9 is a diagram illustrating an example of a configuration of a base station according to one embodiment.

FIG. 10 is a diagram illustrating an example of a configuration of a user terminal according to one embodiment.

FIG. 11 is a diagram illustrating an example of a hardware configuration of the base station and the user terminal according to one embodiment.

FIG. 12 is a diagram illustrating an example of a vehicle according to one embodiment.

### DESCRIPTION OF EMBODIMENTS

### (CSI Report or Reporting)

In Rel-15 NR, a terminal (also referred to as a user terminal or User Equipment (UE), etc.) generates (also described as determines, calculates, estimates, measures, etc.) Channel State Information (CSI) based on a Reference Signal (RS) (or resources for such RS) and transmits (also described as reports, provides feedback, etc.) the generated CSI to a network (for example, a base station). Such CSI may be transmitted to the base station using, for example, an uplink control channel (for example, a Physical Uplink Control Channel (PUCCH)) or an uplink shared channel (for example, a Physical Uplink Shared Channel (PUSCH)).

The RS used for a generation of the CSI may be, for example, at least one of a Channel State Information Reference Signal (CSI-RS), a Synchronization Signal/Broadcast Channel (Synchronization Signal/Physical Broadcast Channel (SS/PBCH)) block, a Synchronization Signal (SS), a reference signal for demodulation (DeModulation Reference Signal (DMRS)), etc.

The CSI-RS may include at least one of a Non Zero Power (NZP) CSI-RS and CSI-Interference Management (CSI-IM). The SS/PBCH block is a block including the SS and the PBCH (and a corresponding DMRS) and may be referred to as an SS block (SSB), etc. The SS may also include at least one of a Primary Synchronization Signal (PSS) and a Secondary Synchronization Signal (SSS).

Note that the CSI may include at least one of a Channel Quality Indicator (CQI), a Precoding Matrix Indicator (PMI), a CSI-RS Resource Indicator (CRI), an SS/PBCH Block Resource Indicator (SSBRI), a Layer Indicator (LI), a Rank Indicator (RI), an L1-RSRP (a reference signal received power for layer 1 (Layer 1 Reference Signal Received Power)), L1-RSRQ (Reference Signal Received Quality), L1-SINR (Signal to Interference plus Noise Ratio), L1-SNR (Signal to Noise Ratio), etc.

The UE may receive information on CSI reporting (report configuration information) and control the CSI reporting based on such report configuration information. Such report configuration information may be, for example, “CSI-ReportConfig” of an Information Element (IE) of a Radio Resource Control (RRC). Note that, in the present disclosure, an RRC IE may be interchangeably read as an RRC parameter, a higher layer parameter, etc.

Such report configuration information (for example, “CSI-ReportConfig” of the RRC IE) may include, for example, at least one of the following:
Information on the type of the CSI reporting (report type information, for example, “reportConfigType” of the RRC IE);
Information on one or more quantities of the CSI to be reported (one or more CSI parameters) (report quantity information, for example, “reportQuantity” of the RRC IE);
Information on the resources for the RS used for a generation of such quantity (such CSI parameters) (resource information, for example, “CSI-ResourceConfigId” of the RRC IE); and
Information on a frequency domain subject to the CSI reporting (frequency domain information, for example, “reportFreqConfiguration” of the RRC IE).

For example, the report type information may indicate Periodic CSI (P-CSI) reporting, Aperiodic CSI (A-CSI) reporting or semi-permanent (partially persistent or Semi-Persistent) CSI reporting (Semi-Persistent CSI (SP-CSI) reporting).

The report quantity information may also specify at least one combination of the CSI parameters (for example, CRI, RI, PMI, CQI, LI, L1-RSRP, etc.) described above.

The resource information may also be an ID of the resources for the RS. Such resources for the RS may include, for example, a Non Zero Power CSI-RS resource or the SSB as well as a CSI-IM resource (for example, a Zero Power CSI-RS resource).

The frequency domain information may also indicate a frequency granularity of the CSI reporting. Such frequency granularity may include, for example, a wideband and a subband. The wideband is an entire CSI reporting band. The wideband may be, for example, a certain entire carrier (Component Carrier (CC), cell or serving cell), or an entire Bandwidth part (BWP) in a certain carrier. The wideband may also be paraphrased as a CSI reporting band or the entire CSI reporting band, etc.

The subband may also be a part in the wideband and may consist of one or more Resource Blocks (RBs) or Physical Resource Blocks (PRBs). The size of the subband may be determined according to the size of the BWP (the number of the PRBs).

The frequency domain information may indicate whether the PMI of the wideband or the subband is to be reported (the frequency domain information may include, for example, “pmi-Formatlndicator” of the RRC IE used for a determination of whether a wideband PMI reporting or a subband PMI reporting is to be reported). The UE may determine the frequency granularity of the CSI reporting (i.e., either the wideband PMI reporting or the subband PMI reporting) based on at least one of the report quantity information and the frequency domain information described above.

When the wideband PMI reporting is configured (determined), one wideband PMI may be reported for the entire CSI reporting band. Conversely, when the subband PMI reporting is configured, one single wideband indication, i1, may be reported for the entire CSI reporting band, and one subband indication, i2, for each of one or more subbands in such entire CSI reporting (for example, a subband indication of each subband) may be reported.

The UE performs channel estimation using a received RS to estimate a Channel matrix H. The UE provides feedback on the index (PMI), which is determined based on an estimated Channel matrix.

The PMI may indicate a precoder matrix (also simply referred to as a precoder) that the UE regards as appropriate to be used for downlink (DL) transmission to the UE. Each value of the PMI may correspond to one precoder matrix. A set of values of the PMI may correspond to a set of a different precoder matrix, which is called a precoder codebook (also simply referred to as a codebook).

For a space domain, the CSI reporting may include one or more types of the CSI. For example, such CSI may include at least one of a first type used for a selection of a single beam (type 1 CSI) and a second type used for a selection of multi beams (type 2 CSI). The single beam may be paraphrased as a single layer, and the multi beams as a plurality of beams. The type 1 CSI does not assume a multi-user multiple input multiple output (MIMO), while the type 2 CSI may assume a multi-user MIMO.

The codebook described above may include a codebook for the type 1 CSI (also referred to as a type 1 codebook, etc.) and a codebook for the type 2 CSI (also referred to as a type 2 codebook, etc.). The type 1 CSI may also include type 1 single-panel CSI and type 1 multi-panel CSI, and a different codebook (a type 1 single-panel codebook or a type 1 multi-panel codebook) may be specified for each.

In the present disclosure, type 1 and type I may be interchangeably read with each other. In the present disclosure, type 2 and type II may be interchangeably read with each other.

An uplink control information (UCI) type may include at least one of a Hybrid Automatic Repeat reQuest ACKnowledgement (HARQ-ACK), a scheduling request (SR) and the CSI. The UCI may be carried by the PUCCH or by the PUSCH.

In Rel-15 NR, the UCI may include one CSI part for wideband PMI feedback. CSI reporting #n includes PMI wideband information if reported.

In Rel-15 NR, the UCI may include two CSI parts for subband PMI feedback. CSI part 1 includes wideband PMI information. CSI part 2 includes one piece of wideband PMI information and several pieces of subband PMI information. CSI part 1 and CSI part 2 are separated to be encoded.

In Rel-15 NR, the UE is configured by a higher layer for a CSI reporting configuration of N (N≥1) report settings and a resource setting of M (M≥1) CSI resource configurations. For example, the CSI reporting configuration (CSI-ReportConfig) includes resource settings for a channel measurement (resourcesForChannelMeasurement), CSI-IM resource settings for interference (csi-IM-ResourceForInterference), NZP-CSI-RS settings for interference (nzp-CSI-RS-ResourceForlnterference), a report quantity (reportQuantity), etc. Each of the resource settings for the channel measurement, the CSI-IM resource settings for interference and the NZP-CSI-RS settings for interference is associated with the CSI resource configurations (CSI-ResourceConfig and CSI-ResourceConfigId). The CSI resource configuration includes a list of CSI-RS resource sets (csi-RS-ResourceSetList, for example, NZP-CSI-RS resource sets or CSI-IM resource sets).

Evaluation and specification of the CSI reporting for a transmission of at least one of a multi TRP of a DL and a multi panel are under study to allow both FR1 and FR2 to enable more dynamic channel/interference hypotheses for an NCJT.

### (Codebook Configuration)

The UE is configured with parameters related to the codebook (a codebook configuration (CodebookConfig)) by a higher layer signaling (RRC signaling). The codebook configuration is included in the CSI reporting configuration (CSI-ReportConfig) of the higher layer (RRC) parameter.

For the codebook configuration, at least one codebook of a type 1 single panel (typeI-SinglePanel), a type 1 multi panel (typeI-MultiPanel), type 2 (typeII) and a type 2 port selection (typeII-PortSelection) is selected.

Parameters of the codebook include parameters related to a codebook subset restriction (CBSR) ( . . . Restriction). The configuration of the CBSR is a bit indicating which PMI report is allowed (“1”) and which PMI report is not allowed (“0”) for the precoder associated with bits of the CBSR. One bit of a CBSR bitmap corresponds to one codebook index/antenna port.

### (CSI Reporting Configuration)

The CSI reporting configuration (CSI-ReportConfig) in Rel. 16 includes the codebook configuration (CodebookConfig) as well as CSI-RS resources for the channel measurement (resourcesForChannelMeasurement (CMR)), CSI-RS resources for an interference measurement (csi-IM-ResourcesForInterference (ZP-IMR) and nzp-CSI-RS-ResourcesForInterference (NZP-IMR)), etc. Parameters of the CSI-ReportConfig, except for codebookConfig-r16, are also included in the CSI reporting configuration in Rel. 15.

In Rel. 17, an enhanced CSI reporting configuration (CSI-ReportConfig) for a CSI measurement/reporting of the multi TRP using the NCJT is under study. In such CSI reporting configuration, two CMR groups corresponding to each of the two TRPs are configured. The CMR in the CMR groups may be used for the measurement of at least one of the multi TRP and a single TRP using the NCJT. N CMR pairs of the NCJT are configured by the RRC signaling. The UE may be configured whether to use the CMR of the CMR pair for the measurement of the single TRP by the RRC signaling.

For the CSI reporting related to an NCJT measurement of the multi TRP/panel, which is configured by a single CSI reporting configuration, at least one of the following options 1 and 2 is under study to be supported.

### <Option 1>

The UE is configured to report X (X=0, 1 or 2) CSIs related to a single TRP measurement tentative/hypotheses and one CSI related to the NCJT measurement. When X=2, the two pieces of CSI relate to two different single TRP measurements using the CMR of a different CMR group.

### <Option 2>

The UE may be configured to report one piece of CSI related to a best measurement result out of the measurement hypotheses for the NCJT and the single TRP.

As described above, in Rel. 15/16, the CBSR is configured for each codebook configuration for each CSI reporting configuration. In other words, the CBSR is applied to all CMRs, etc. in the corresponding CSI reporting configuration.

Note, however, that the CSI reporting configuration for the multi TRP in Rel. 17 by the CSI reporting configuration may lead to the following measurement configurations when options 1 and 2 described above are applied.

Option 1 (X=0): measurement only of the CSI of the NCJT.
Option 1 (X=1): measurement of the CSI of the NCJT and the CSI of the single TRP (one TRP).
Option 1 (X=2): measurement of the CSI of the NCJT and the CSI of the single TRP (two TRPs).
Option 2: measurement of both the CSI of the NCJT and the CSI of the single TRP.

### (Type 1 Codebook)

The type 1 single-panel codebook and the type 1 multi-panel codebook are specified for a base station panel. For the type 1 single panel, an antenna model of a CSI antenna port array (logical configuration) is specified for the number of CSI-RS antenna ports P_{CSI-RS} and (N₁, N₂). For the type 1 multi panel, the antenna model of the CSI antenna port array (logical configuration) is specified for the number of CSI-RS antenna ports P_{CSI-RS} and (N_{g}, N₁, N₂).

For Rel-15 type 1 single panel CSI, the UE is set to the type 1 single panel (‘typeI-SinglePanel’) with the higher layer parameter of a codebook type (a subType in type1 in a codebookType in the CodebookConfig). If not a number of layers v∈{2, 3, 4}, a PMI value corresponds to three codebook indices i_{1,1}, i_{1,2} and i₂. If the number of layers v∈{2, 3, 4}, the PMI value corresponds to four codebook indices i_{1,1}, i_{1,2}, i_{1,3} and i₂. If not the number of layers v∈{2, 3, 4}, composite codebook indices iᵢ=[i_{1,1}, i_{1,2}]. If the number of layers v∈{2, 3, 4}, the composite codebook indices i₁=[i_{1,1}, i_{1,2}, i_{1,3}].

For a number of CSI antenna ports P_{CSI-RS}, configurations (combinations of values) of supported (N₁, N₂) and (O₁, O₂) are specified in a specification. (N₁, N₂) indicates a number of antenna elements in two dimensions and is configured by n1−n2 in a moreThanTwo in an nrOfAntennaPorts in the typeI-SinglePanel. (O₁, O₂) is an oversampling factor in two dimensions. i_{1,1} corresponding to horizontal beams is {0, 1, . . . , N₁O₁−1}. i_{1,2} corresponding to vertical beams is {0, 1, . . . , N₂O₂−1}. i₂ is {0, 1, 2, 3}. For codebook mode (codebookMode)=1, a matrix for a 1-layer CSI reporting codebook using antenna ports 3000 to 2999+P_{CSI-RS} is W_i_{1,1}, i_{1,2}, i₂\hat{ }(1). Here, W_{l,m,n}⁽¹⁾ is given by the following equation.

$${W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ] \qquad ( X1 )$$

For Rel-15 type 1 multi-panel CSI, the number of panels N_{g} is configured in addition to N₁ and N₂ when compared to the type 1 single panel. i,_{1,4} is additionally reported as an inter-panel phase matching (inter-panel co-phasing, phase compensation between panels, phase adjustment/phase difference between panels). A same SD beam (precoding matrix W) is selected for each panel and only the inter-panel phase matching is added and reported.

For the number of CSI antenna ports P_{CSI-RS} configurations (combinations of values) of supported (N_{g}, N₁, N₂) and (O₁, O₂) are specified in the specification. (N₁, N₂) is configured by ng−n1−n2 in the typeI-MultiPanel. i_{1,1} is {0, 1, . . . , N₁O₁−1}. i_{1,2} is {0, 1, . . . , N₂O₂−1}. For q=1, . . . , N_{g}−1, i_{1,4,q} is {0, 1, 2, 3}. i₂ is {0, 1, 2, 3}. For codebook mode (codebookMode)=1, a matrix for the 1-layer CSI reporting codebook using antenna ports 3000 to 2999+P_{CSI-RS} is W_i_{1,1}, i_{1,2}, i_{1,4}, i₂\hat{ }(1), where, W_{l,m,p,n}⁽¹⁾=W_{l,m,p,n}\hat{ }, N_{g}, 1.

W_l, m, p, n\hat{ }1, N_{g}, 1 and W_l, m, p, n\hat{ }2, N_{g}, 1 for Ng={2, 4}(a matrix W_{l,m,p,n}^{1,2,1} for a first layer, N_{g}=2 and codeBookMode=1; a matrix W_{l,m,p,n}^{2,2,1} for a second layer, Ng=2 and codeBookMode=1; a matrix W_{l,m,p,n}^{1,4,1} for the first layer, Ng=4 and codeBookMode=1; and a matrix W_{l,m,p,n}^{2,4,1} for the second layer, Ng=4 and codeBookMode=1) are given by the following equations.

$${W}_{l , m , p , n}^{1 , 2 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ] \\ {W}_{l , m , p , n}^{2 , 2 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m}\end{matrix} ] \\ {W}_{l , m , p , n}^{1 , 4 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ] \\ {W}_{l , m , p , n}^{2 , 4 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m} \\ {φ}_{{p}_{2}} {v}_{l , m} \\ - {φ}_{n} {φ}_{{p}_{2}} {v}_{l , m} \\ {φ}_{{p}_{3}} {v}_{l , m} \\ - {φ}_{n} {φ}_{{p}_{3}} {v}_{l , m}\end{matrix} ] \qquad ( X2 )$$

where, φₙ=e^{jπn/2}. p=p₁ for N_{g}=2, and p=[p₁, p₂, p₃] for N_{g}=4. φ_p₁, φ_p₂ and φ_p₃ represent the inter-panel phase matching (inter-panel co-phasing). A same beam (an SD beam matrix and the precoding matrix W₁) is selected for panels 0, 1, 2 and 3, where φ_p₁ represents the phase compensation of panel 1 for panel 0, φ_p₂ represents the phase compensation of panel 2 for panel 0, and φ_p₃ represents the phase compensation of panel 3 for panel 0.

### (Type 2 Codebook)

CSI acquisition for a coherent joint transmission (CJT) for FR1 and up to four TRPs is under study, assuming an ideal backhaul, synchronization and a same number of antenna ports across a plurality of TRPs. Improvements of the type 2 codebook of Rel. 16/17 are under study for a CJT multi TRP for an FDD.

In the present disclosure, the X-by-Y matrix Z may be represented as Z (X×Y).

For the type 2 CSI of Rel. 15, for a given layer k, a generation of a precoding vector for each subband SB-wise) is based on the following equation.

$${W}_{k} ( {N}_{t} \times {N}_{3} ) = {W}_{1} {W}_{2 , k} \qquad ( Y1 )$$

Nₜ is the number of ports. N₃ is a total number of precoding matrices (precoders) as indicated by the PMI (number of subbands). W₁(Nₜ×2L) is a matrix consisting of L∈{2, 4} (oversampled) spatial domain (SD) two-dimensional (2D) DFT vectors (SD beam, 2D-DFT vector) (SD beam matrix). L is the number of beams. For example, L=2 SD 2D-DFT vectors are bᵢ and bⱼ, respectively. W_{2,k}(2L×N₃) is a subband complex linear combination (LC) coefficients (combination coefficients) matrix for layer k. W_{2,k} represents beam selection and phase matching (co-phasing) between two polarizations. For example, two W_{2,k} are cᵢ and cⱼ, respectively. For example, the channel matrix h is approximated by a linear combination cᵢbᵢ, +cⱼbⱼ of the L=2 SD 2D-DFT vectors. An overhead of the feedback is mainly a result of an LC coefficient matrix W_{2,k}. The type 2 CSI of Rel. 15 also supports only ranks 1 and 2.

The type 2 CSI of Rel. 16 reduces the overhead related to W_{2,k} by a compression of the frequency domain (FD). The type 2 CSI of Rel. 16 supports ranks 3 and 4 as well as ranks 1 and 2.

For the type 2 CSI of Rel. 16, information based on the following equation may be reported by the UE for a given layer k.

$${W}_{k} = {W}_{1} {W}_{k}^{\sim} {W}_{f , k}^{H} \qquad ( Y2 )$$

W_{2,k} is approximated by W\tilde{ }ₖW_{f,k}^{H}. The matrix W\tilde{ } may be represented by a W with a ˜ above it (w tilde). The matrix W_{f,k}^{H} is an adjoint matrix of W_{f,k}.

For the CSI reporting, the UE may be configured with one of two subband sizes. These subbands (CQI subbands) are defined as N_{PRB}^{SB} consecutive PRBs and may depend on a total number of PRBs in the BWP. The number of PMI subbands per CQI subband, R, is configured by the RRC IE (numberOfPMI-SubbandsPerCQI-Subband). R controls the total number of precoding matrices N; represented by the PMI as a function of the number of subbands configured in a csi-ReportingBand, the subband size configured by a subbandSize and the total number of the PRBs in the BWP.

W₁(Nₜ−2L) is a matrix consisting of a plurality of (oversampled) spatial domain (SD) 2D-DFT (vector and beam). For this matrix, a plurality of indices of a two-dimensional discrete Fourier transform (2D-DFT) vector and an over-sampling factor in two dimensions are reported. A response/distribution of the spatial domain represented by the SD 2D-DFT vector may be referred to as the SD beam.

W\tilde{ }ₖ(2L×Mᵥ) is a matrix consisting of combination coefficients (subband complex linear combination (LC) coefficients). For this matrix, K non-zero coefficients (NZCs) are reported at a maximum. That report consists of two parts: a bitmap capturing an NZC position and a quantization NZC.

W_{f,k}(N₃×Mᵥ) is a matrix consisting of a plurality of frequency domain (FD) bases (vectors) for layer k. There are Mᵥ FD bases (FD DFT bases) for each layer. If N₃>19, Mᵥ DFTs from an intermediate subset (InS) with a size of N₃′ (<N₃) are selected. If N₃≤19, a log 2 (C(N₃−1, Mᵥ−1)) bit is reported, where C(N₃−1, Mᵥ−1) is the number of combinations to choose Mᵥ−1 from N₃−1, also called binomial coefficients. The response/distribution of the frequency domain (frequency response) represented by the linear combination of an FD base vector and the combination coefficient may be referred to as an FD beam. The FD beam may correspond to a delay profile (time response).

A subset of the FD base is given as {f₁, . . . , f_{Mv}}, where fᵢ is an i-th FD base for a k-th layer and i∈{1, . . . , Mᵥ}. A PMI subband size is given by a CQI subband size/R, where R∈{1, 2}. The number of FD bases Mᵥ for a given rank v is given by ceil(pᵥ×N₃/R). The number of FD bases is the same for all layers k∈{1, 2, 3, 4}. pᵥ is configured by the higher layer.

Each row of the matrix W_{2,k} represents a channel frequency response of a specific SD beam. If the SD beam is highly directional, a channel tap for each beam is limited (a power-delay profile becomes sparse in a time domain). As a result, the channel frequency response for each SD beam is highly correlated (it approaches a flat line in the frequency domain). In this case, the channel frequency response can be approximated by the linear combination of a small number of FD bases. For example, if Mᵥ=2, the frequency response associated with the SD beam b₀ is approximated by d₁⁰f₂+ and d₂⁰f_{q} using the FD bases f₂ and f_{q} as well as a linear combination coefficient d₁⁰ and d₂⁰.

The Mᵥ FD bases with the highest gain are selected. By making Mᵥ<<N₃, the overhead of W\tilde{ }ₖ is significantly smaller than that of W_{2,k}. All or part of the MW FD bases are used for an approximation of the frequency response of each SD beam. The bitmap is used to report only the FD bases selected for each SD beam. If the bitmap is not reported, all FD bases are selected for each SD beam. In this case, for each SD beam, the nonzero coefficients (NZCs) of all FD bases are reported. For the maximum number of the NZC in one layer, Kₖ^{NZ}≤K₀=ceil(β×2LMᵥ), and for the maximum number of the NZC across all layers, K^{NZ}≤2K₀=ceil(β×2LMᵥ). β is configured by the higher layer.

Each complex coefficient to be reported in Wₖ is a separately quantized amplitude and phase.

### [Amplitude Quantization]

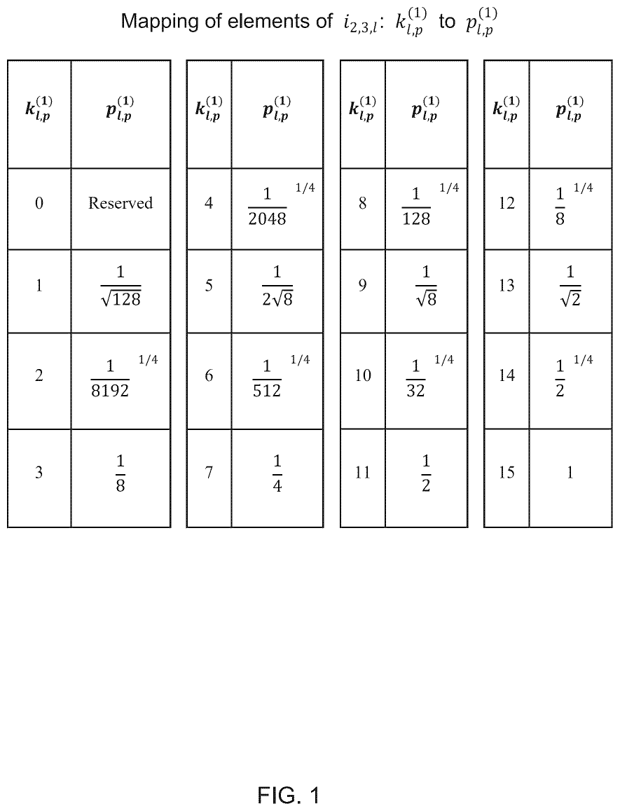

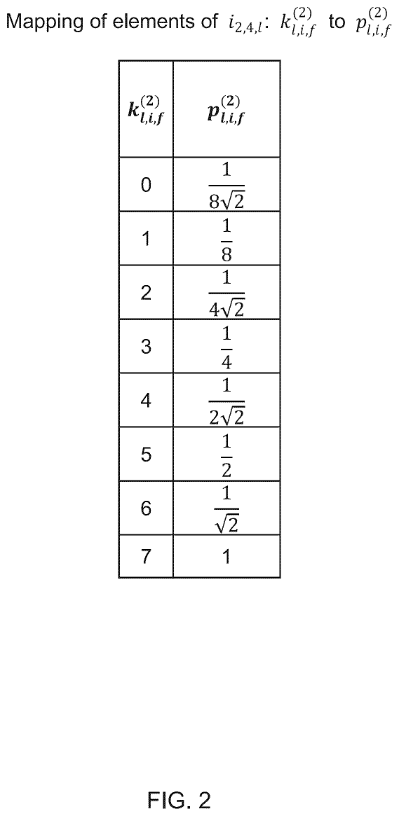

A polarization-specific reference amplitude is a 16-level quantization using the table in FIG. 1 (a mapping of a plurality of elements of an amplitude coefficient indicator i_{2,3,1}: a mapping from an element k_{l,p}⁽¹⁾ to an amplitude coefficient p_{l,p}^{(l)}). All other coefficients are eight-level quantization using the table in FIG. 2 (the mapping of the plurality of elements of an amplitude coefficient indicator i_{2,4,1}: the mapping from the element k_{l,i,f}⁽²⁾ to the amplitude coefficient p_{l,i,f}⁽²⁾).

### [Phase Quantization]

All coefficients are quantized using 16-PSK. For example, φ_{l,i}=exp(j2πc_{l,i}/16), c_{l,i}∈{0, . . . , 15}, where c_{l,i} is a phase coefficient to be reported by the UE (using four bits) for an associated phase value φ_{l,i}.

Type 2 CSI feedback on the PUSCH of Rel. 16 includes two parts. CSI part 1 has a fixed payload size and is used for an identification of the number of information bits in CSI part 2. A size of part 2 is variable (a UCI size depends on the number of non-zero amplitude coefficients (NZCs), the number of which is not known to the base station). The UE reports the number of the NZCs in CSI part 1, which determines the size of CSI part 2. The base station recognizes the size of CSI part 2 after receiving CSI part 1.

For enhanced type 2 CSI feedback, CSI part 1 includes the RI, the CQI and an indication of a total number of non-zero amplitudes across a plurality of layers for an enhanced type 2 CSI. Fields of part 1 are separately encoded. CSI part 2 includes the PMI of the enhanced type 2 CSI. Part 1 and part 2 are separately encoded. CSI part 2 (PMI) includes at least one of the oversampling factor, an index of a 2D-DFT base, an index Mᵢₙᵢₜᵢₐₗ of an initial DFT base (starting offset) of a selected DFT window, the DFT base selected for each layer, a non-zero LC coefficient (NZC, amplitude and phase) of each layer, a strongest (of maximum intensity) coefficient indicator (SCI) of each layer and an amplitude of the strongest coefficient of each layer/polarization.

A plurality of PMI indices (PMI values, codebook indices) associated with different CSI part 2 information may be according to the following for the k-th layer.
i_{1,1}: oversampling factor
i_{1,2}: plurality of indices of indices of the 2D-DFT base
i_{1,5}: index of the initial DFT base of the selected DFT window (starting offset), Mᵢₙᵢₜᵢₐₗ
i_{1,6,k}: DFT base selected for the k-th layer
i_{1,7,k}: bitmap for the k-th layer
i_{1,8,k}: strongest (of maximum intensity) coefficient indicator (SCI) for the k-th layer
i_{2,3,k}: amplitude of the strongest coefficient of the k-th layer (for both polarizations)
i_{2,4,k}: amplitude of a reported coefficient of the k-th layer
i_{2,5,k}: phase of the reported coefficient of the k-th layer

i_{1,5} and i_{1,6,k} are the PMI indices for a DFT base reporting. Only if N₃>19, i_{1,5} is reported.

As a grouping of CSI part 2, for a given CSI report, PMI information is organized into three groups (groups 0 through 2). This is important when CSI omission is performed. Each element to be reported of indices i_{2,4,1}, i_{2,5,1} and i_{1,7,1} are associated with a specific priority rule. Groups 0 through 2 are subject to the following:
Group 0: indices i_{1,1}, i_{1,2} and i_{1,8,1} (L=1, . . . , v);
Group 1: index i_{1,5} (if reported), highest (higher) v2LMᵥ-floor (K^{NZ}/2) priority elements in indices i_{1,6,1} and i_{1,7,1} (if reported), highest (higher) ceil(K^{NZ}/2)−v priority elements in i_{2,3,1} and i_{2,4,1}, and highest (higher) ceil(K^{NZ}/2)−v priority elements in i_{2,5,1} (l=1, . . . , v); and
Group 2: lowest (lower) floor(K^{NZ}/2) priority elements in i_{1,7,1}, lowest (lower) floor(K^{NZ}/2) priority elements in i_{2,4,1} and lowest (lower) floor(K^{NZ}/2) priority elements in i_{2,5,1} (l=1, . . . , v).

For the type 1 CSI, the SD beam represented by an SD DFT vector is transmitted to the UE. For the type 2 CSI, the L SD beams are linearly combined and transmitted to the UE. Each SD beam can be associated with a plurality of FD beams. For the corresponding SD beams, the channel frequency response can be obtained by the linear combination of their FD base vectors. The channel frequency response corresponds to the power-delay profile.

### (Type 2 Port Selection Codebook)

For type 2 port selection (PS) CSI in Rel. 16, the type 2 PS codebook (CB) does not require the UE to derive the SD beam in consideration of the 2D-DFT in a normal type 2 CB. Instead, the base station transmits the CSI-RS using K CSI-RS ports beamformed in consideration of a set of SD beams. The UE identifies best L (SK) CSI-RS ports and reports their indices in W₁.

For layer k∈{1, 2, 3, 4}, a precoder generation for each subband (subband (SB)-wise) is given by the following equation.

$${W}_{k} ( {N}_{t} \times {N}_{3} ) = {QW}_{1} {W}_{k}^{\sim} {W}_{f , k}^{H} \qquad ( Y3 )$$

where Q(Nₜ×K) represents K SD beams used for CSI-RS beamforming. W₁(K×2L) is a block diagonal matrix. W\tilde{ }ₖ(2L×M) is the LC coefficient matrix. W_{f,k}(N₃×M) consists of N₃ DFT base vectors (FD base vectors). K is configured by the higher layer. L is configured by the higher layer. P_{CSI-RS}∈{4, 8, 12, 16, 24, 32}. In the case of P_{CSI-RS}>4, L∈{2, 3, 4}.

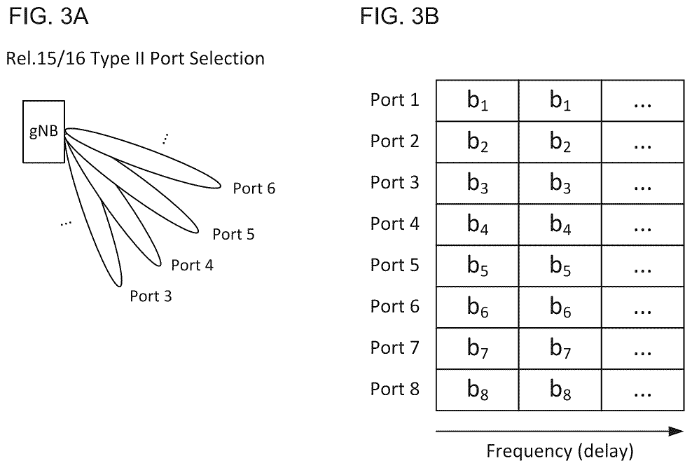

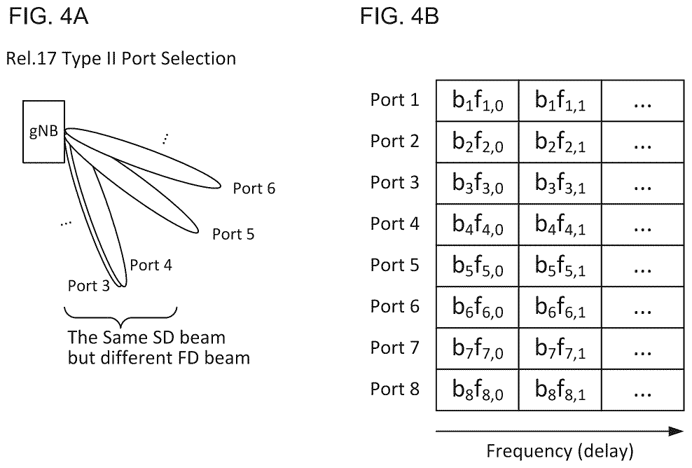

For a CSI/codebook of the type 2 port selection in Rel. 15/16, each CSI-RS port #i is associated with the SD beam (bᵢ) (FIGS. 3A and 3B). For the CSI/codebook of the type 2 port selection in Rel. 17 (enhanced type 2 port selection codebook), each CSI-RS port #i is associated with an SD-FD beam pair (a pair of the SD beam bᵢ and the FD beam f_{i,j} (j is a frequency index)) instead of the SD beam (FIGS. 4A and 4B). In this example, ports 3 and 4 are associated with the same SD beam and different FD beams.

Frequency selectivity of the channel frequency response observed on the UE based on a pair of SD beam—FD beam can be reduced compared to the frequency selectivity of the channel frequency response observed on the UE based on the SD beam by a delay pre-compensation.

A primary scenario of the type 2 port selection codebook of Rel. 17 is the FDD. Although channel reciprocity based on an SRS measurement is not perfect, the base station can obtain several pieces of partial information. In addition to the CSI reporting, the base station can obtain the CSI for a determination of a DL MIMO precoder by using the SRS measurement at the base station. In this case, several CSI reportings may be omitted to reduce a CSI overhead.

For type 2PS CSI of Rel. 17, each CSI-RS port is beamformed using the SD beam and the FD base vector. Each port is associated with a pair of SD-FD.

Information based on the following equation may be reported by the UE for a given layer k.

$${W}_{k} ( K \times {N}_{3} ) = {W}_{1} {W}_{k}^{\sim} {W}_{f , k}^{H} \qquad ( Y4 )$$

For Wₗ(K×2L), each matrix block consists of an L column of a K×K identity matrix. The base station transmits K beamformed CSI-RS ports. Each port is associated with a pair of SD-FD. The UE selects L ports out of K ports and reports them to the base station as part of the PMI (W_{l,k}). In Rel. 16, each port is associated with the SD beam.

W\tilde{ }ₖ(2L×Mᵥ) is a matrix consisting of the coupling coefficients (subband complex LC coefficients). K₀ NZCs are reported at a maximum. The report consists of two parts: a bitmap capturing the NZC position and the quantization NZC. In a specific case, the bitmap can be omitted. In Rel. 16, the bitmap of the NZC position is always reported.

W_{f,k}(N₃×Mᵥ) is a matrix consisting of the N₃ FD base (FD DFT base) vectors. There are the Ms. FD bases for each layer. The base station may delete W_{f,k}. If W_{f,k} is on, Mᵥ additional FD bases are reported. If W_{f,k} is off, additional FD bases are not reported. In Rel. 16, W_{f,k} is always reported.

### (Doppler Shift)

A use of a time-domain correlation/Doppler-domain information to enhance/improve the CSI reporting for the UE moving at high/medium speed is under study. For example, improving the type 2 codebook of Rel. 16/17 without changing a spatial domain base and a frequency domain base, as well as reporting time domain channel characteristics measured via CSI-RS for tracking (tracking RS (TRS)) from the UE, is under study.

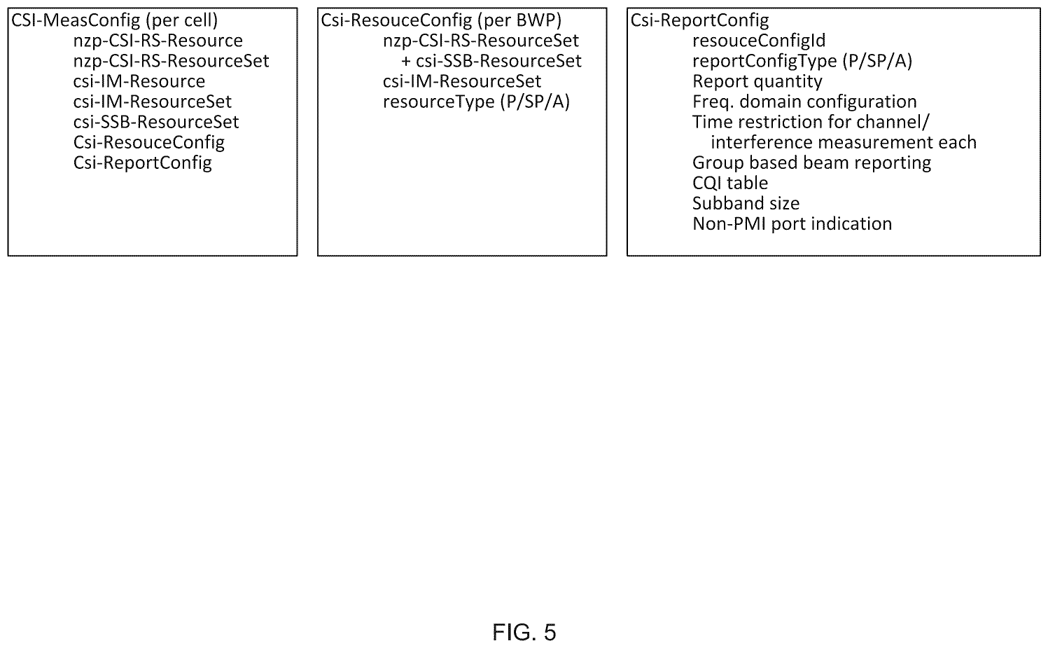

As shown in the example in FIG. 5, the relationship between the CSI-RS resource and the CSI reporting is configured by a CSI measurement configuration (CSI-MeasConfig), which is configured for each cell, the CSI resource configuration (CSI-ResourceConfig), which is configured for each BWP, and the CSI reporting configuration (CSI-ReportConfig).

A channel coherent time (CCT) depends on a maximum Doppler shift. The channel coherent time is either the time that measured channel characteristics are available or the time until the measured channel characteristics are no longer available (channel aging). The maximum Doppler shift is estimated by a relative speed between a transmitter and a receiver. The channel coherent time T_{C} is approximated by 1/Δfₘₐₓ, where Δfₘₐₓ=v/λ. As a movement speed of the UE increases, the channel coherent time decreases. For example, at a carrier frequency of 4.5 GHz, the channel coherent time is less than 10 ms when the movement speed exceeds about 25 km/h. How to deal with such high movement speeds and such a short channel coherent time is a problem.

The TRS is supported to track the Doppler shift. However, the TRS has the following problems.
The number of ports per CSI-RS resource set is limited to only one. Each CSI-RS resource uses a single port.
The period that can be configured is 10 ms or longer.
No CSI reporting for the TRS is assumed. There are no reporting configurations for a P-TRS. A reporting can be configured, but the report quantity (reportQuantity) is only set to none. A maximum of 16 CSI-RS resources are used per CSI-RS resource set.

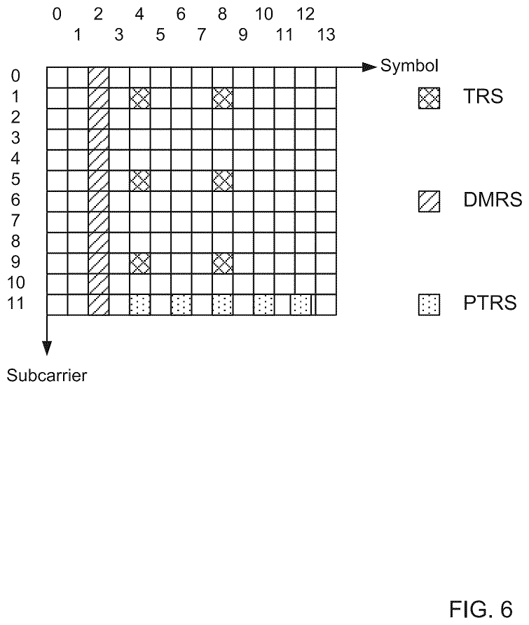

The TRS is allocated to resources of the time domain and the frequency domain, as shown in the example in FIG. 6. A plurality of RSs in the time domain are needed in a specific frequency domain resource for the measurement of impacts of the Doppler shift.

The CMR may be utilized to measure the impacts of the Doppler shift. However, the RS used for the measurement depends on a UE implementation.

For an amount of the CSI reporting, information on the Doppler shift is not supported. Information for the determination of W=W₁W₂ is reported by the UE via a CSI codebook (PMI), Here, W₁ is a wideband characteristic and indicates a spatial beam. W₂ is a subband characteristic and indicates a coefficient of the amplitude/phase for each spatial beam.

For the measurement on the Doppler shift, there are two possible cases: case 1, in which the UE performs the measurement based on the CSI-RS, and case 2, in which the base station performs the measurement based on an SRS. For a judgment of the impacts of the Doppler shift, there are three possible cases: case 1-1, in which the UE makes the judgment based on CSI-RS measurement results; case 1-2, in which the base station makes the judgment based on CSI-RS measurement results reported by the UE; and case 2-1, in which the base station makes the judgment based on SRS measurement results.

In such cases 1-1/1-2, the details of the CSI-RS, for example, an RS resource configuration, are not clear. For example, it is not clear whether the TRS or the RS other than the TRS is used. In addition, the details of the reporting are not clear. For example, what information is to be reported, what RS resource is to be measured, conditions for reporting, etc. are not clear. If such measurement/reporting on the Doppler shift is not clear, the communication throughput, etc., may be degraded.

Therefore, the inventors of the present invention came up with the idea of a method of measurement/reporting on the Doppler shift.

The following is a detailed description of an embodiment according to the present disclosure with reference to the drawings. Note that each of the following embodiments (for example, each case) may be used alone, or at least two of them may be applied in combination.

In the present disclosure, “A/B” and “at least one of A and B” may be interchangeably read with each other. In the present disclosure, “A/B/C” may also mean “at least one of A, B and C.”

In the present disclosure, activate, deactivate, direct (or indicate), select, configure, update, determine, etc. may be interchangeably read with each other. In the present disclosure, support, control, can control, operate, can operate, etc. may be interchangeably read with each other.

In the present disclosure, Radio Resource Control (RRC), RRC parameter, RRC message, higher layer parameter, Information Element (IE), configuration, etc. may be interchangeably read with each other. In the present disclosure, Medium Access Control Control Element (MAC Control Element (CE)), update command, activation/deactivation command, etc. may be interchangeably read with each other.

In the present disclosure, the higher layer signaling may be, for example, any of a Radio Resource Control (RRC) signaling, a Medium Access Control (MAC) signaling or broadcast information, or a combination thereof.

In the present disclosure, the MAC signaling may use, for example, the MAC Control Element (MAC CE), an MAC Protocol Data Unit (PDU), etc. The broadcast information may be, for example, a Master Information Block (MIB), a System Information Block (SIB), a minimum system information (Remaining Minimum System Information (RMSI)), Other System Information (OSI), etc.

In the present disclosure, a physical layer signaling may be, for example, Downlink Control Information (DCI), the Uplink Control Information (UCI), etc.

In the present disclosure, index, Identifier (ID), indicator, resource ID, etc. may be interchangeably read with each other. In the present disclosure, sequence, list, set, group, family, cluster, subset, etc. may be interchangeably read with each other.

In the present disclosure, panel, panel group, beam, beam group, precoder, Uplink (UL) transmission entity, Transmission/Reception Point (TRP), base station, Spatial Relation Information (SRI), spatial relation, SRS Resource Indicator (SRI), COntrol REsource SET (CORESET), Physical Downlink Shared Channel (PDSCH), Codeword (CW), Transport Block (TB), Reference Signal (RS), antenna port (for example, DeModulation Reference Signal (DMRS) port), antenna port group (for example, DMRS port group), group (for example, spatial relation group, Code Division Multiplexing (DCM) group, reference signal group, CORESET group, Physical Uplink Control Channel (PUCCH) group, PUCCH resource group), resource (for example, reference signal resource, SRS resource), resource set (for example, reference signal resource set), CORESET pool, downlink Transmission Configuration Indication state (TCI state) (DL TCI state), uplink TCI state (UL TCI state), unified TCI state, common TCI state, quasi co-location (Quasi-Co-Location (QCL)), QCL assumption, etc. may be interchangeably read with each other.

In the present disclosure, time domain resource allocation and time domain resource assignment may be interchangeably read with each other.

In the present disclosure, beam, SD beam, SD vector and SD 2D-DFT vector may be interchangeably read with each other. L, number of SD beams, number of beams and number of SD 2D-DFT vectors may be interchangeably read with each other.

In the present disclosure, FD base, FD DFT base, DFT base and fᵢ may be interchangeably read with each other. In the present disclosure, FD beam, FD vector, FD base vector, FD DFT base vector and DFT base vector may be interchangeably read with each other.

In the present disclosure, combination coefficient, LC coefficient, subband complex LC coefficient and combination coefficient matrix may be interchangeably read with each other.

In the present disclosure, panel, base station (gNB) panel and TRP may be interchangeably read with each other.

In the present disclosure, co-phasing, phase matching, phase compensation, phase adjustment, phase difference and phase relationship may be interchangeably read with each other.

In the present disclosure, layer k and layer l may be interchangeably read with each other.

In the present disclosure, TRS, NZP-CSI-RS resource set accompanied by TRS information (trs-Info) and NZP-CSI-RS resource with the same port for all NZP-CSI-RS resources may be interchangeably read with each other.

### (Radio Communication Method)

In each embodiment, time-domain correlation, time correlation, cross correlation, Doppler domain information, Doppler shift and impacts caused by Doppler shift may be interchangeably read with each other. In each embodiment, CSI for the use of the time domain correlation/Doppler domain information, CSI for moving at high speed, CSI for the UE moving at high speed and high speed (HS) CSI may be interchangeably read with each other.

In each embodiment, CSI-RS resource, repetition and NZP-CSI-RS resource may be interchangeably read with each other.

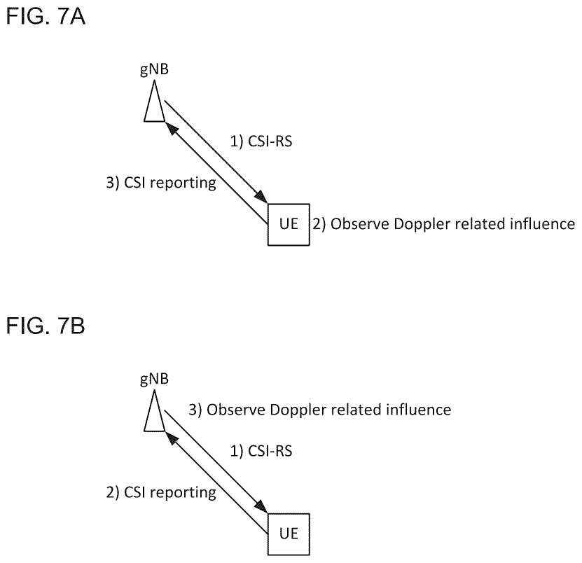

Each of the following embodiments may be applied to cases 1-1/1-2 described above. In case 1-1, the UE measures the CSI-RS from the base station, judges impacts related to the Doppler shift based on the measurement results and reports the CSI based on the judgment results (FIG. 7A). In case 1-2, the UE measures the CSI-RS from the base station, and the UE reports the CSI based on the measurement results. The base station judges the impacts related to the Doppler shift based on the CSI (FIG. 7B).

### Embodiment #1

This embodiment relates to the CSI-RS resource.

For the use of the time domain correlation/Doppler domain information, a specific NZP-CSI-RS-resource set (NZP-CSI-RS-ResourceSet) may be configured. Any reporting configuration associated with that specific NZP-CSI-RS resource set may be used for the use of the time domain correlation/Doppler domain information.

### <<Option 1>>

A specific resource set condition required for the specific NZP-CSI-RS resource set may be that the NZP-CSI-RS resource set meets at least one of the following several resource set conditions or at least two of the following several resource set conditions at the same time.
Condition related to whether or not the TRS is used. The condition may be any of the following.
   [Resource set condition 1-1a] That NZP-CSI-RS resource set is configured as the TRS (it is configured accompanied by the TRS information (trs-Info)).
   [Resource set condition 1-1b] That NZP-CSI-RS resource set is not configured as the TRS (it is configured not accompanied by the TRS information).
Condition related to the time domain resource.
   [Resource set condition 1-2] That NZP-CSI-RS resource set includes a plurality of NZP-CSI-RS resources accompanied by a plurality of different symbols.
Condition related to the frequency domain resource.
   [Resource set condition 1-3] That NZP-CSI-RS resource set includes the plurality of NZP-CSI-RS resources accompanied by a same frequency domain position (RE/subcarrier).
   [Resource set condition 1-4] That NZP-CSI-RS resource set includes the plurality of NZP-CSI-RS resources accompanied by a same density of the frequency domain resource.
Condition related to the ports
   [Resource set condition 1-5] That NZP-CSI-RS resource set includes the plurality of NZP-CSI-RS resources accompanied by a same number of ports.
Condition related to whether or not the use/purpose of that NZP-CSI-RS resource set or resource is explicitly configured to be the use of the time domain correlation/Doppler domain information.
   [Resource set condition 1-6] That NZP-CSI-RS resource set is configured accompanied by a specific parameter. For example, the specific parameter indicates the time domain correlation (timeDomainCorrelation).
   [Resource set condition 1-7] That NZP-CSI-RS resource set is configured accompanied by a specific parameter. For example, the specific parameter indicates the Doppler information (dopplerInformation).
Condition related to whether the repetition is turned on or off. The condition may be any of the following.
   [Resource set condition 1-8a] That NZP-CSI-RS resource set is configured accompanied by the repetition=on.
   [Resource set condition 1-8b] That NZP-CSI-RS resource set is configured accompanied by the repetition=off or not accompanied by a repetition configuration.
Condition related to whether or not a plurality of starting symbols are configured for one or more NZP-CSI-RS resources in that NZP-CSI-RS resource set.
   [Resource set condition 1-9a] All NZP-CSI-RS resources in that NZP-CSI-RS resource set are configured accompanied by the plurality of starting symbols.
   [Resource set condition 1-9b] All NZP-CSI-RS resources in that NZP-CSI-RS resource set are configured accompanied by a symbol offset for a determination of a second starting symbol.
   [Resource set condition 1-10a] More than one NZP-CSI-RS resource in that NZP-CSI-RS resource set is configured accompanied by the plurality of starting symbols.
   [Resource set condition 1-10b] More than one NZP-CSI-RS resource in that NZP-CSI-RS resource set is configured accompanied by the symbol offset for the determination of the second starting symbol.
   [Resource set condition 1-11a] At least one of the NZP-CSI-RS resources in that NZP-CSI-RS resource set is configured accompanied by the plurality of starting symbols.
   [Resource set condition 1-11b] At least one of the NZP-CSI-RS resources in that NZP-CSI-RS resource set is configured accompanied by the symbol offset for the determination of the second starting symbol.

The plurality of starting symbols may be represented using the symbol offset between the plurality of starting symbols or the second starting symbol. The plurality of starting symbols may be determined by any of the following methods of determination.
The plurality of starting symbols is specified in the specification.
The plurality of starting symbols are configured by the RRC IE.
The plurality of starting symbols are directed by the MAC CE/DCI.
A plurality of candidate values of the plurality of starting symbols are specified in the specification or configured by the RRC IE, and one or more of the plurality of candidate values is directed by the MAC CE/DCI.

The plurality of starting symbols may differ from a first OFDM symbol in the time domain (firstOFDMSymbolInTimeDomain)/a first OFDM symbol in the time domain 2 (firstOFDMSymbolInTimeDomain2).

### <<Option 2>>

(With respect to condition 1-2) The symbol offset between a plurality of different NZP-CSI-RS resources or a plurality of different repetitions may be limited. The limitation may be at least one of the following several limitations.

### [Limitation 2-1]

That symbol offset is specified as a fixed offset in the specification. For example, the fixed offset may be three symbols or four symbols.

### [Limitation 2-2]

That symbol offset is configured by the RRC IE. Although that symbol offset can be configured by the RRC, it may only be a specific offset available for the purposes of Embodiment #1.

### [Limitation 2-3]

That symbol offset is directed by the MAC CE/DCI.

### [Limitation 2-4]

It may be determined by a combination of limitations 2-1 through 2-3. For example, a set of fixed values may be specified in the specification, and one or more values from that set may be configured by the RRC IE. For example, a set of values may be specified by the RRC IE in the specification, and one or more values from that set may be directed by the MAC CE/DCI. That DCI may be for a triggering of an A-CSI-RS transmission. For example, the set of fixed values may be specified in the specification, and one or more values from that set may be directed by the MAC CE/DCI.

According to this embodiment, the CSI-RS resource for the measurement on the Doppler shift can be properly configured/directed.

### Embodiment #2

This embodiment relates to information to be reported.

Specific information may be reported by the UE for the use of the time domain correlation/Doppler domain information. This allows the base station to obtain information for a more preferable precoder for the UE moving at high/medium speed.

### <<Option 1>>

The specific information may include at least one of the following several elements.

[Element 1-1] The Doppler shift or a frequency domain offset.
[Element 1-2] Correlation of a plurality of measured RS resources (time domain correlation).
[Element 1-3] The difference between the measurement results based on the plurality of RSs for a plurality of different time domain resources. For example, a phase offset (phase difference) between that plurality of RSs (received signals). It may be the phase offset between the two RSs that provides a best time domain correlation.
[Element 1-4]A plurality of individual measurement results corresponding to each of the plurality of measured RSs.
[Element 1-5] Whether or not a type 1 CSI codebook is configured.
[Element 1-6] Whether or not a type 2 CSI codebook is configured. If the type 2 CSI codebook is not configured, the type 1 CSI codebook may be reported.

### <<Option 2>>

A method of reporting the specific information may include at least one of the following several methods of reporting. [Method of reporting 2-1] The specific information is reported in a reporting on the CSI codebook (PMI). That CSI codebook may be type 1, type 2 or the type 2 port selection. [Method of reporting 2-2] The specific information may be individually reported for each report quantity.

### <<Option 3>>

### [Option 3-1]

A granularity of a reporting of the specific information may be at least one of the following several granularities.
The reporting of the specific information may be for each of specific frequency domain units. That specific frequency domain unit may be at least one of the following.
   [[Granularity 1]] The reporting of the specific information may be for each of the widebands.
   [[Granularity 2]] The reporting of the specific information may be for each of the sidebands.
The reporting of the specific information may be for each of specific time domain units. For example, the reporting of the specific information may be for each of a plurality (specific number) of reporting values.
The reporting of the specific information may be for each of the NZP-CSI-RS resources or for each of the repetitions. That NZP-CSI-RS resource may be an NZP-CSI-RS resource other than a reference NZP-CSI-RS resource.
The reporting of the specific information may be for each of the SD beams or for each of the NZP-CSI-RS resources. That NZP-CSI-RS resource may be the NZP-CSI-RS resource other than the reference NZP-CSI-RS resource. The reporting of the specific information may be for each of the SD beams or for each of the repetitions.
The reporting of the specific information may be for each of the FD beams, for each of the SD beams or for each of the NZP-CSI-RS resources. That NZP-CSI-RS resource may be an NZP-CSI-RS resource other than the reference NZP-CSI-RS resource. The reporting of the specific information may be for each of the FD beams, for each of the SD beams or for each of the repetitions.
The reporting of the specific information may be for each of the NZP-CSI-RS resource sets. That reporting may be associated with one or more NZP-CSI-RS resources in that NZP-CSI-RS resource set. Those one or more NZP-CSI-RS resources may be the NZP-CSI-RS resources other than the reference NZP-CSI-RS resources.

The specific information may be common to the two polarizations or polarization-specific.

The specific information may be common to all layers or layer-specific.

For example, if four CSI-RS resources are configured for the specific information, a first CSI-RS resource may be the reference NZP-CSI-RS resource for the Doppler shift. The Doppler shift of a second/third/fourth CSI-RS resource may be measured based on the first CSI-RS resource and reported. The Doppler shift of the second CSI-RS resource may be based on the first CSI-RS resource. The Doppler shift of the third CSI-RS resource may be based on the second CSI-RS resource. The Doppler shift of the fourth CSI-RS resource may be based on the third CSI-RS resource. The Doppler shift of the first (reference) CSI-RS resource may not be reported.

### [Variation of Option 3-1]

As described above, the reporting of the specific information may be for each of the NZP-CSI-RS resource sets. That reporting may be associated with one or more NZP-CSI-RS resources in that NZP-CSI-RS resource set. Those one or more NZP-CSI-RS resources may be the NZP-CSI-RS resources other than the reference NZP-CSI-RS resources.

Which NZP-CSI-RS resource is referenced for reporting and how the NZP-CSI-RS resource is determined may be according to at least one of the following several methods of determination.

### [Method of Determination 1-1]

The reference NZP-CSI-RS resource is explicitly configured/directed/determined. One or more CSI-RS resource IDs may be configured/directed. The configuration/direction may be performed by the RRC IE/MAC CE/DCI.

### [Method of Determination 1-2]

The reference NZP-CSI-RS resource is implicitly configured/directed/determined. The reference NZP-CSI-RS resource may be the several CSI-RS resources accompanied by the symbols of a first to x-th from the last symbol of the starting symbols of each of the CSI-RS resources in that CSI-RS resource set (first OFDM symbols). The value x may be specified in the specification, configured by the RRC IE or directed by the MAC CE/DCI. The reporting from the UE may be created based on one of the symbols of the first to x-th from the last symbol and one other resource. The one other resource may be the CSI-RS resource accompanied by the earliest starting symbols, the CSI-RS resource accompanied by a lowest ID, the CSI-RS resource configured by the RRC IE or the CSI-RS resource directed by the MAC CE/DCI.

### [Method of Determination 1-3]

The reference NZP-CSI-RS resource is implicitly configured/directed/determined. The reference NZP-CSI-RS resource may be the several CSI-RS resources accompanied by the starting symbol that is Y symbols after the starting symbol of the one other resource (the first OFDM symbols). The one other resource may be the CSI-RS resource accompanied by the earliest starting symbols, the CSI-RS resource accompanied by the lowest ID, the CSI-RS resource configured by the RRC IE or the CSI-RS resource directed by the MAC CE/DCI.

### [Option 3-2]

A granularity of a reporting of the PMI may be at least one of the following several granularities.
The reporting of the PMI may be for each of the specific frequency domain units. That specific frequency domain unit may be at least one of the following.
   [[Granularity 1]] The reporting of the PMI may be for each of the widebands.
   [[Granularity 2]] The reporting of the PMI may be for each of the sidebands.
The reporting of the PMI may be for each of the specific time domain units. For example, the reporting of the PMI may be for each of the plurality (specific number) of reporting values.
The reporting of the PMI may be for each of the NZP-CSI-RS resources or for each of the repetitions. That NZP-CSI-RS resource may be the NZP-CSI-RS resource other than the reference NZP-CSI-RS resource.
The reporting of the PMI may be for each of the SD beams or for each of the NZP-CSI-RS resources. That NZP-CSI-RS resource may be the NZP-CSI-RS resource other than the reference NZP-CSI-RS resource. The reporting of the PMI may be for each of the SD beams or for each of the repetitions.
The reporting of the PMI may be for each of the FD beams, for each of the SD beams or for each of the NZP-CSI-RS resources. That NZP-CSI-RS resource may be the NZP-CSI-RS resource other than the reference NZP-CSI-RS resource. The reporting of the PMI may be for each of the FD beams, for each of the SD beams or for each of the repetitions.
The reporting of the PMI may be for each of the NZP-CSI-RS resource sets. That reporting may be associated with one or more NZP-CSI-RS resources in that NZP-CSI-RS resource set. Those one or more NZP-CSI-RS resources may be the NZP-CSI-RS resources other than the reference NZP-CSI-RS resources. Which NZP-CSI-RS resource is referenced for reporting and how the NZP-CSI-RS resource is determined may be according to variation a of option 3 described above.

The PMI may be common to the two polarizations or polarization-specific.

The PMI may be common to all layers or layer-specific.

### [Variation of Option 3-2]

The reporting of the PMI may be for each of the NZP-CSI-RS resource sets. That reporting may be associated with one or more NZP-CSI-RS resources in that NZP-CSI-RS resource set. Those one or more NZP-CSI-RS resources may be the NZP-CSI-RS resources other than the reference NZP-CSI-RS resources. Which NZP-CSI-RS resource is referenced for reporting and how the NZP-CSI-RS resource is determined may be according to “variation of option 3-1” described above.

### [Option 3-3]

Options 3-1 and 3-2 may be combined.

### Example 1

The specific information and the PMI may be reported for each of the NZP-CSI-RS resources. In this case, the CSI reporting (for one CSI-RS resource set) may include N pieces of the specific information and N PMIs. According to this example, the CSI from each resource can be considered together with corresponding specific information, providing better CSI quality for high-speed/medium-speed movement.

### Example 2

The specific information may be reported for each of the NZP-CSI-RS resources, and the PMI may be reported for each of the NZP-CSI-RS resource sets. In this case, the CSI reporting (for one CSI-RS resource set) may include the N pieces of the specific information and one PMI. According to this example, the overhead of the PMI reporting is smaller.

### Example 3

The specific information and the PMI may be reported for each of the NZP-CSI-RS resource sets, and the PMI may be reported for each of the NZP-CSI-RS resources. In this case, the CSI reporting (for one CSI-RS resource set) may include one piece of specific information and the N PMIs. According to this example, the overhead of the specific information reporting is smaller.

The PMI may be reported using one of the following several codebooks.
Rel-15 type 1 single-panel codebook.
Rel-15 type 1 multi-panel codebook.
Rel-15 type 2 codebook.
Rel-15 type 2 port selection codebook.
Rel-16 (enhanced) type 2 codebook.
Rel-16 (enhanced) type 2 port selection codebook.
Rel-17 (further enhanced) type 2 port selection codebook.
Rel-18 new codebook. This codebook may be based on the type 1/type 2/type 2 port selection codebook of an earlier release.

According to this embodiment, the specific information/PMI on the Doppler shift can be properly reported.

### Embodiment #3

This embodiment relates to the RS to be measured for reporting.

For the use of the time domain correlation/Doppler domain information, one or more NZP-CSI-RS resources may be narrowed down from a plurality of configured NZP-CSI-RS resources based on the condition. This allows any NZP-CSI-RS resource set to be used for the use of the time domain correlation/Doppler domain information.

### <<Option 1

Those one or more NZP-CSI-RS resources may be at least one of the following several resources.

### [Resource 1-1]

Those one or more NZP-CSI-RS resources may be resources accompanied by a same frequency domain resource configuration.

[Resource 1-2a]

Those one or more NZP-CSI-RS resources may be resources accompanied by symbols that are different from each other or resources accompanied by time domain resource configurations that are different from each other.

[Resource 1-2b]

Those one or more NZP-CSI-RS resources may be resources that meet a limitation of the symbol offset and are accompanied by symbols that are different from each other, or resources accompanied by the time domain resource configurations that are different from each other. That limitation may be that the symbol offset is a specific number or smaller, or that the symbol offset is larger than a specific number. That limitation may be that the symbol offset is a specific number or that the symbol offset is not a specific number.

### [Resource 1-3]

Those one or more NZP-CSI-RS resources may be resources accompanied by the same number of ports.

### <<Option 2>

The selection of those one or more NZP-CSI-RS resources may be according to at least one of the following several methods of selection.

### [Method of Selection 2-1]

An associated CSI reporting configuration may be configured with information for an identification of the RS (resource) to be measured. The information for the identification of the RS (resource) to be measured may be the time domain information. That time domain information may indicate a slot/symbol at which the RS to be measured is positioned or the offset of the slot/symbol between a plurality of RSs to be measured. The information for the identification of the RS (resource) to be measured may be an NZP-CSI-RS Resource ID(s) (NZP-CSI-RS-ResourceId(s)) to be measured.

### [Variation 1 of Example #3]

This variation relates to the CSI reporting to the TRS.

The CSI reporting configuration to the TRS may be configured for the use of the time domain correlation/Doppler domain information.

An actual (measured) TRS resource may be narrowed down from a configured TRS resource. A method of selection of option 2 of Embodiment #3 described above may be applied to a selection of the actual TRS resource.

### [Variation 2 of Example #3]

This variation relates to the CSI reporting to the TRS.

The CSI reporting configuration to more than one NZP-CSI-RS resource set may be configured for the use of the time domain correlation/Doppler domain information.

That more than one NZP-CSI-RS resource set may be at least one of the following several resource sets.

[Resource set 1-1] Only more than one NZP-CSI-RS resource set configured as the TRS.
[Resource set 1-2]A combination of one or more NZP-CSI-RS resource sets configured as the TRS and one or more NZP-CSI-RS resource sets not configured as the TRS.
[Resource set 1-3] Only more than one NZP-CSI-RS resource set not configured as the TRS.

According to this embodiment, the RS to be measured for a reporting on the Doppler shift can be properly determined.

### Embodiment #4

This embodiment relates to conditions for the CSI reporting.

If specific reporting conditions are met, the CSI reporting for the use of the time domain correlation/Doppler domain information may be configured. The specific reporting conditions may be that one of the following several reporting conditions is met or that at least two of the following several reporting conditions are met at the same time.
Condition related to a report quantity configuration (reportQuantity).
   [Reporting condition 1-1] The report quantity configuration configures the PMI reporting.
   [Reporting condition 1-2] The report quantity configuration configures a new value (a newly specified value). The new value may be independent of an existing value. For example, the new value may indicate the time domain correlation (timeDomainCorrelation) or the Doppler shift (dopplerShift).
   [Reporting condition 1-3] The report quantity configuration configures i₁ reporting of the PMI reporting (wideband reporting).
Condition related to the codebook configuration (codebookConfig).
   [Reporting condition 1-4] The codebook configuration configures type 1. A subtype may be the type 1 single panel (typeI-SinglePanel) or the type 1 multi panel (typeI-MultiPanel).
   [Reporting condition 1-5] The codebook configuration configures type 2. The subtype may be type 2 (typeII) or the type 2 port selection (typeII-PortSelection).
Condition related to a configuration related to the CSI-RS resource.
   [Reporting condition 1-6]A resource type (resourceType) configures periodic, semi-persistent or aperiodic.

According to this embodiment, under appropriate conditions, the reporting on the Doppler shift can be performed.

### Embodiment #5

This embodiment relates to a UE operation.

The following operation may be specified in the specification for the use of the time domain correlation/Doppler domain information.
The UE may calculate the time domain correlation for the resource in Embodiment #1 and may report it.

The time domain correlation C_{τ} may be given by the following equation.

$${C}_{τ} = 1 / N \cdot {Σ}_{t = 0}^{N - 1} {f}^{H} ( t ) g ( t + τ )$$

where N is a number of time domain samples in one symbol. The reporting value to be associated may be C_{τ} for each τ to be considered, the maximum C_{τ} for each τ to be considered and τ used for a calculation of the maximum value of C_{τ}. In the specification, the time domain correlation may be represented as an amount of phase rotation (in the time domain) (phase difference in two time domain resources). f(t) and g(t) may be received signals for two NZP-CSI-RS resources, respectively. Those two NZP-CSI-RS resources may be allocated to different time domain resources (for example, symbols).

If at least one of the following several operating conditions is met, the UE operation may be performed.
The NZP-CSI-RS resource to be measured meets one of the resource set conditions in Embodiment #1.
The associated reporting configuration configures the NZP-CSI-RS resource for measurement that meets one of the resource set conditions in Embodiment #1.
The associated reporting configuration configures the reporting corresponding to Embodiment #2.
The associated reporting configuration meets a resource condition of any of the reporting conditions in Embodiment #4.

According to this embodiment, the UE operation for the reporting on the Doppler shift can be properly performed.

### <Supplemental>

At least one of the embodiments described above may be applied only to the UE that has reported a specific UE capability or that supports such specific UE capability.

Such specific UE capability may indicate at least one of the following:
to support a specific process/operation/control/information for at least one of the embodiments described above;
to support the CSI reporting of at least one of the embodiments described above;
to support the type 1 CSI codebook accompanied by the CSI of at least one of the embodiments described above;
to support the type 2 CSI codebook or a type 2 CSI port selection codebook accompanied by the CSI of at least one of the embodiments described above;
to support an enhanced type 2 CSI codebook or an enhanced type 2 CSI port selection codebook accompanied by the CSI of at least one of the embodiments described above; and
to support a further enhanced type 2 CSI port selection codebook accompanied by the CSI of at least one of the embodiments described above.

The specific UE capability described above may also be a capability that applies across all frequencies (in common regardless of frequency), a capability for each frequency (for example, cell, band and BWP), a capability for each frequency range (for example, Frequency Range 1 (FR1), FR2, FR3, FR4, FR5, FR2-1 and FR2-2) or a capability for each subcarrier spacing (SubCarrier Spacing (SCS)).

The specific UE capability described above may also be a capability that applies across all duplex systems (in common regardless of duplex system) or a capability for each duplex system (for example, Time Division Duplex (TDD) and Frequency Division Duplex (FDD)).

At least one of the embodiments described above may also be applied when the UE is configured with specific information related to the embodiments described above by the higher layer signaling. For example, such specific information may be information indicating an activation of a function of at least one of the embodiments described above, any RRC parameter for a specific release (for example, Rel. 18), etc.

When the UE does not support at least one of the specific UE capabilities described above or is not configured with the specific information described above, the operation of, for example, Rel. 15/16/17 may be applied.

(Supplementary Note) Regarding one embodiment of the present disclosure, the following supplementary notes of the invention will be given.

### {Supplementary Note 1}

A terminal including:
a control section that performs a measurement on a Doppler shift of a channel state information (CSI)-reference signal (RS) and determines channel state information (CSI) based on the measurement; and
a transmitting section that transmits a reporting of the CSI.

### {Supplementary Note 2}

The terminal according to supplementary note 1, wherein the measurement is based on a configuration of a resource set of the CSI-RS for the Doppler shift.

### {Supplementary Note 3}

The terminal according to supplementary note 1 or 2, wherein the CSI includes information related to the Doppler shift or a time domain correlation.

### {Supplementary Note 4}

The terminal according to any one of supplementary notes 1 to 3, wherein a plurality of resources of the CSI-RS is accompanied by at least one of a same frequency domain resource and a different symbol.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

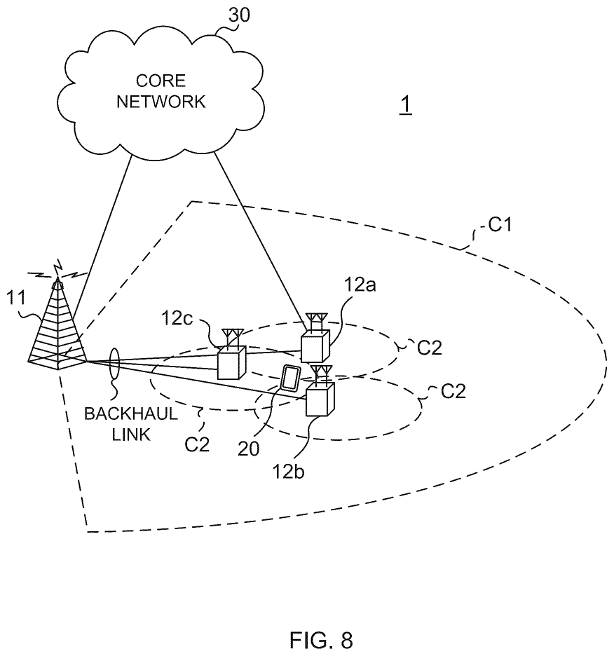

FIG. 8 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

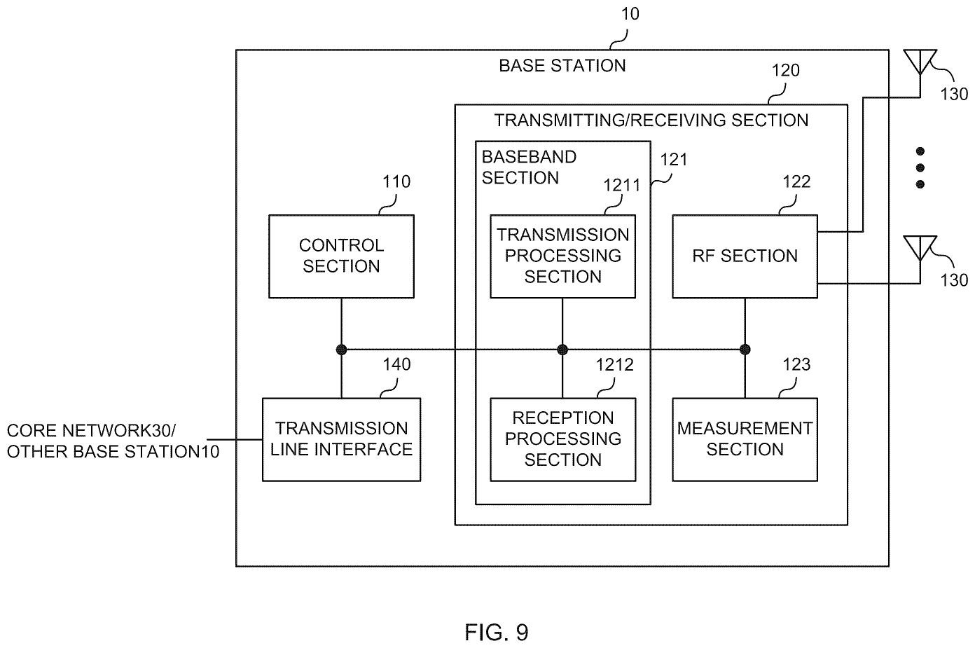

FIG. 9 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RPM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The control section 110 may determine a configuration of a measurement on a Doppler shift of a channel state information (CSI)-reference signal (RS). The transmitting/receiving section 120 may transmit the configuration.

### (User Terminal)

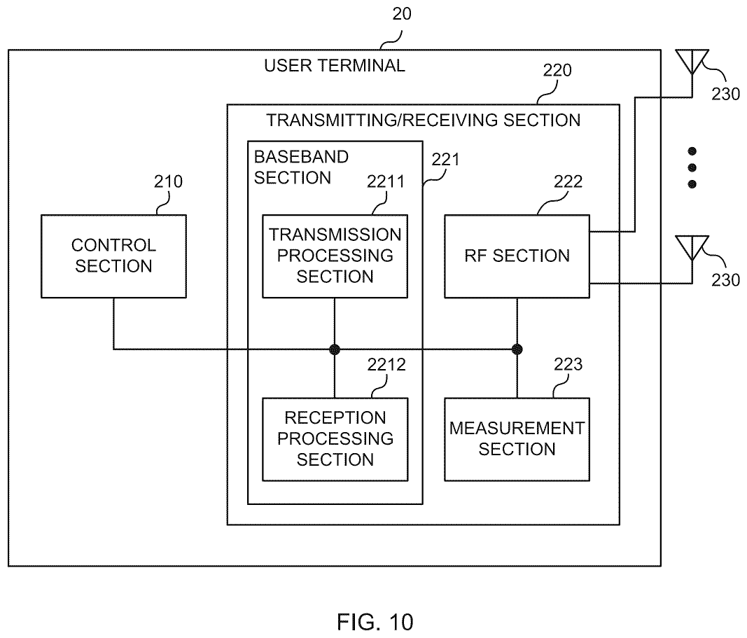

FIG. 10 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may perform a measurement on a Doppler shift (for example, use of time domain correlation/Doppler domain information) of a channel state information (CSI)-reference signal (RS) and determines channel state information (CSI) based on the measurement.

The transmitting/receiving section 220 may transmit a reporting of the CSI.

The measurement may be based on a configuration of a resource set (for example, NZP-CSI-RS resource set/NZP-CSI-RS resource) of the CSI-RS for the Doppler shift.

The CSI may include information related to the Doppler shift (for example, a phase offset between a plurality of RSs and a measurement result of each of the plurality of RSs) or a time domain correlation.

A plurality of resources of the CSI-RS may be accompanied by at least one of a same frequency domain resource and a different symbol.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

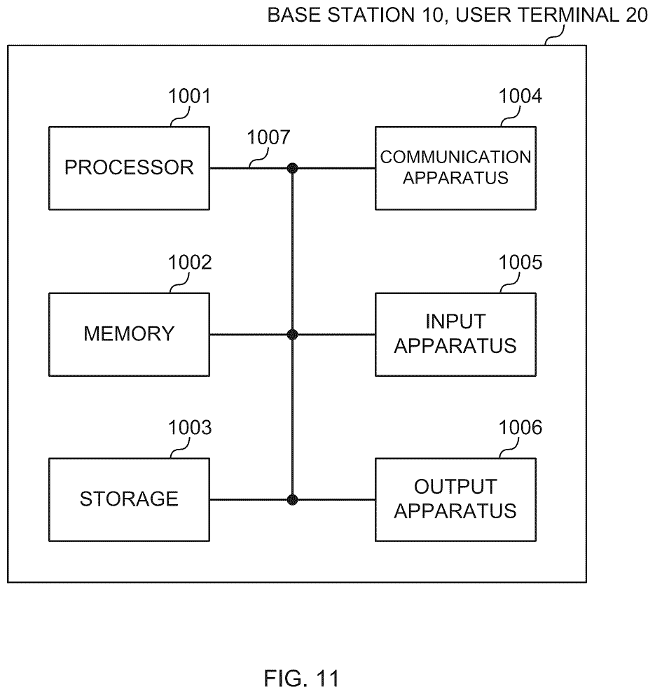

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the base station transmitting information to the terminal may be interchangeably interpreted as the base station indicating control/operation based on the information to the terminal.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

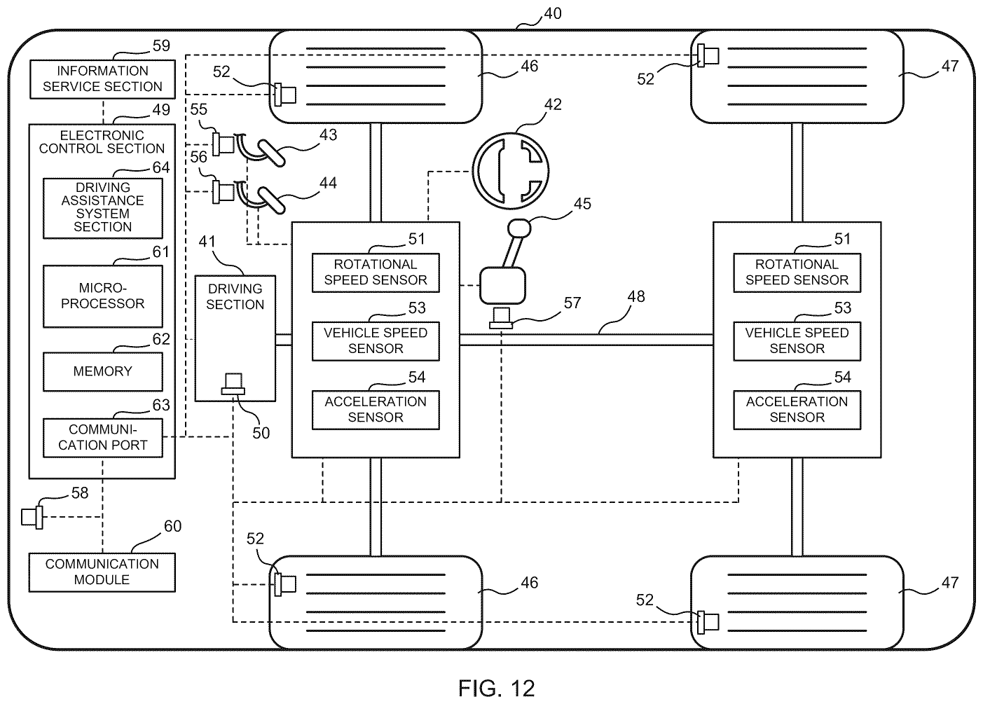

FIG. 12 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that performs a measurement on a Doppler shift of a channel state information (CSI)-reference signal (RS) and determines channel state information (CSI) based on the measurement; and
a transmitting section that transmits a reporting of the CSI.

2. The terminal according to claim 1, wherein
the measurement is based on a configuration of a resource set of the CSI-RS for the Doppler shift.

3. The terminal according to claim 1, wherein
the CSI includes information related to the Doppler shift or a time domain correlation.

4. The terminal according to claim 1, wherein
a plurality of resources of the CSI-RS is accompanied by at least one of a same frequency domain resource and a different symbol.

5. A radio communication method for a terminal, comprising:
performing a measurement on a Doppler shift of a channel state information (CSI)-reference signal (RS) and determining channel state information (CSI) based on the measurement; and
transmitting a reporting of the CSI.

6. A base station comprising:
a control section that determines a configuration of a measurement on a Doppler shift of a channel state information (CSI)-reference signal (RS); and
a transmitting section that transmits the configuration.
